(19) United States
(12) Patent Application Publication
(10) Pub. No.: US 2014/0367998 A1
(43) Pub. Date: Dec. 18, 2014

(54) LOAD FLOOR FOR A VEHICLE

(71) Applicant: GM GLOBAL TECHNOLOGY OPERATIONS LLC, Detroit, MI (US)

(72) Inventors: Sergio Lavastida, Toluca (MX); Adrian Rodriguez, Toluca (MX)

(21) Appl. No.: 13/919,055

(22) Filed: Jun. 17, 2013

(51) Int. Cl. B62D 25/20

(52) U.S. Cl. CPC B62D 25/20
USPC 296/193.07

(57) ABSTRACT

A load floor for a vehicle includes a first facing layer and a substrate layer. The first facing layer presents a first inner surface. The substrate layer presents a first outer surface and a second outer surface in opposition to the first outer surface. The substrate layer defines a plurality of cells that extend between the first outer surface and the second outer surface.

### TECHNICAL FIELD

The disclosure relates to a load floor for a vehicle.

### BACKGROUND

Vehicles may include a load floor that is configured to support cargo in a cargo area. For example, minivans and sport-utility vehicles typically include a cargo area in the rear of the vehicle. Access to the cargo area is provided by a rear body opening that is selectively closed by a rear closure panel, such as a tailgate or a liftgate. Similarly, pickup trucks include a cargo area, i.e., a cargo box, with access to the cargo box being provided by an opening at the rear of the truck and that is selectively closed by a tailgate. The load floor forms the lower surface of the cargo area or cargo box.

### SUMMARY

In one aspect of the disclosure, a load floor for a vehicle includes a first facing layer and a substrate layer. The first facing layer presents a first inner surface. The substrate layer presents a first outer surface and a second outer surface in opposition to the first outer surface. The substrate layer defines a plurality of cells bounded by at least one wall extending between the first outer surface and the second outer surface.

In another aspect of the disclosure, a vehicle includes a floor panel, a tub portion, and a load floor. The tub portion is located adjacent the floor panel and defines a cargo space having an opening in the floor panel. The load floor is configured to selectively cover the opening and supporting various loads positioned thereon. The load floor includes a first facing layer and a substrate layer. The first facing layer presents a first inner surface. The substrate layer presents a first outer surface and a second outer surface in opposition to the first outer surface. The substrate layer defines a plurality of cells bounded by at least one wall extending between the first outer surface and the second outer surface.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic perspective rear view of a vehicle interior having a load floor;

FIG. 2 is a schematic cross-sectional side view of the load floor of FIG. 1, taken along line 2-2, illustrating the load floor covering a tub of the vehicle;

FIG. 3 is an exploded perspective view of the load floor;

FIG. 4 is a schematic partial perspective view of a substrate layer of the load floor taken from section 4 of FIG. 3; and

FIG. 5 is a schematic perspective view of the load floor.

### DETAILED DESCRIPTION

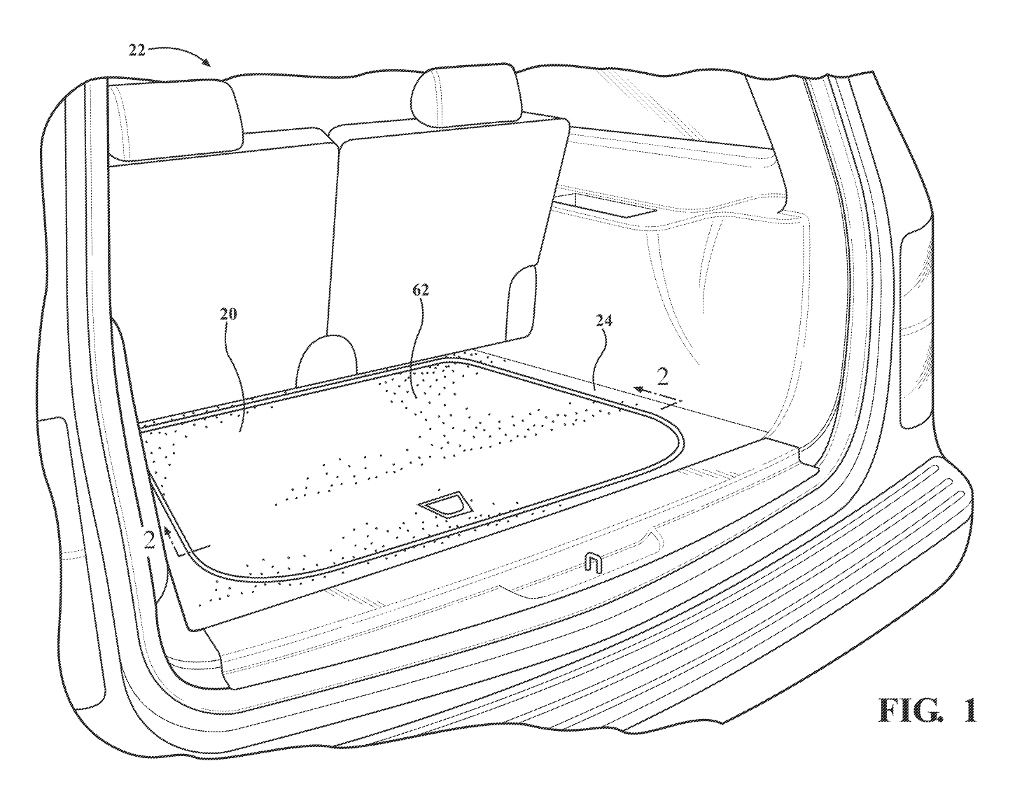

Referring to the drawings, wherein like reference numbers correspond to like or similar components whenever possible throughout the several figures, there is shown in FIG. 1 a load floor 20 for a vehicle 22. The vehicle 22 also includes a floor panel 24 and a tub portion 26. The tub portion 26 is located below the floor panel 24, relative to the ground, and defines a cargo space 28 having an opening 30 in the floor panel 24. The floor panel 24 and the tub portion 26 may be formed from a single sheet of material or may be formed from separate sheet of material. The tub portion 26 may be configured to house a spare tire, luggage, and the like.

The load floor 20 is configured for selectively covering and uncovering the opening 30 in the floor panel 24 and supporting various loads 32 positioned thereon when the load floor 20 is in the closed position. In one embodiment, the load floor 20 may be movably attached to the floor panel 24, e.g., hingedly attached and the like. Alternatively, the load floor 20 is removably disposed in the opening 30 of the floor panel 24. The load floor 20 is configured to selectively conceal the contents within the tub portion 26, while providing a surface for supporting the loads 32 of items placed on top of or above the tub portion 26.

The load floor 20 includes a first facing layer 34, a second facing layer 36, and a substrate layer 38 bonded to one another to form a sandwich structure bounded by a peripheral edge 37. The first and second facing layers 34, 36 are formed from a material that provides rigidity to the load floor 20 when the first and second facing layers 34, 36 are bonded to the substrate layer 38. The first facing layer 34 and the second facing layer 36 may be formed from a material that includes polypropylene, polyurethane, thermoplastic, glass fiber, wood, hardboard, natural fiber, and the like.

The first facing layer 34 presents a first inner surface 40 and the second facing layer 36 presents a second inner surface 42. The substrate layer 38 presents a first outer surface 44 and a second outer surface 46 in opposition to the first outer surface 44. A first adhesive layer 48 may be disposed between the first inner surface 40 and the first outer surface 44. The first adhesive layer 48 bonds the first facing layer 34 to the substrate layer 38. A second adhesive layer 50 may be disposed between the second outer surface 46 and the second inner surface 42. The second adhesive layer 50 bonds the second facing layer 36 to the substrate layer 38. The first and second facing layers 34, 36 may be heated to cure the first and second adhesive layers 48, 50. It should be appreciated that the first and second adhesive layers 48, 50 may be cured in other ways. The first and second adhesive layers 48, 50 bond the respective first and second facing layers 34, 36 to the substrate layer 38 such that the load floor 20 is configured to support a load 32 within the vehicle 22, without deflecting or breaking More specifically, the load floor 20 is configured to support at least 50 kilograms (kg) of weight with no more than 20 millimeters of deflection in an up/down direction, relative to the ground, and no thermoset.

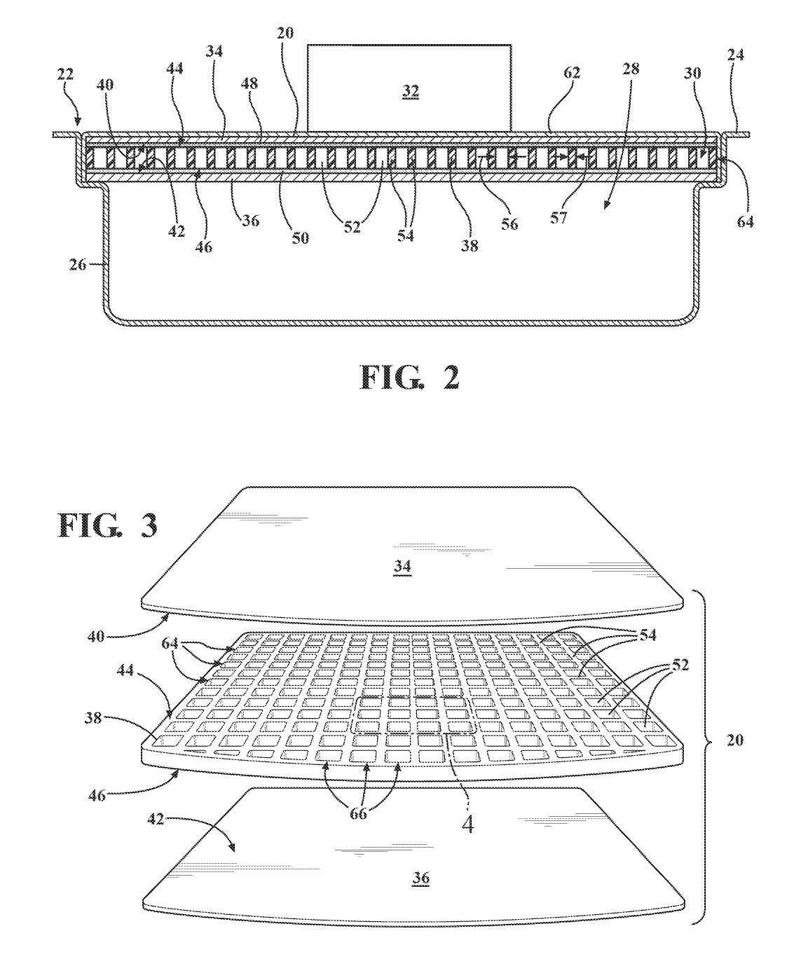

The substrate layer 38 defines a plurality of cells 52 that extend between the first outer surface 44 and the second outer surface 46 to provide a hollow-structured substrate layer 38. More specifically, referring to FIGS. 2-4, each cell 52 is bounded by walls 54 that extend between the first outer surface 44 and the second outer surface 46. The cells 52 may have a square-shaped profile bounded by four walls 54. However, it should be appreciated that profiles having other shapes and/or numbers of walls 54 may also be used. By way of a non-limiting example, the cells 52 may have a circular-shaped profile, bounded by one wall 54, a triangular-shaped profile, bounded by three walls 54, a pentagon-shaped profile bounded by five walls 54, and the like. The walls 54 bounding each cell 52 may have lengths 56, 58 that are equal to one another.

Referring to FIGS. 2-4, the cells 52 of the substrate layer 38 may be aligned in a plurality of rows 64 and a plurality of columns 66. The cells 52 may be arranged in rows 64 and columns 66 that are uniformly spaced in perpendicular relationship to one another to form a grid-like pattern. In the embodiment with the cells 52 having the square-shaped profile shown in FIGS. 2-4, the cells 52 are bounded by four walls 54. The walls 54 extending in a direction of the rows 64 have a first length 56 and the walls 54 extending in a direction of the columns 66 have a second length 58. The walls 54 of the cells 52 have a first thickness 57 that spaces the cells 52 from one another along each of the rows 64 and a second thickness 59 that spaces the cells 52 from one another along each of the columns 66. In one embodiment, the first thicknesses 57 are equal to the second thicknesses 59. By way of a non-limiting example, the first thicknesses 57 and the second thicknesses 59 is approximately ⅓ of the length of the walls 54. In another embodiment, the first thicknesses 57 are not equal to the second thicknesses 59.

The substrate layer 38 may be formed from a material that includes a cellular material, such as high density, crushable foam, other cellular material, and the like. The cellular material may be high density foam. By way of a non-limiting example, the high density foam may, for example, include polypropylene.

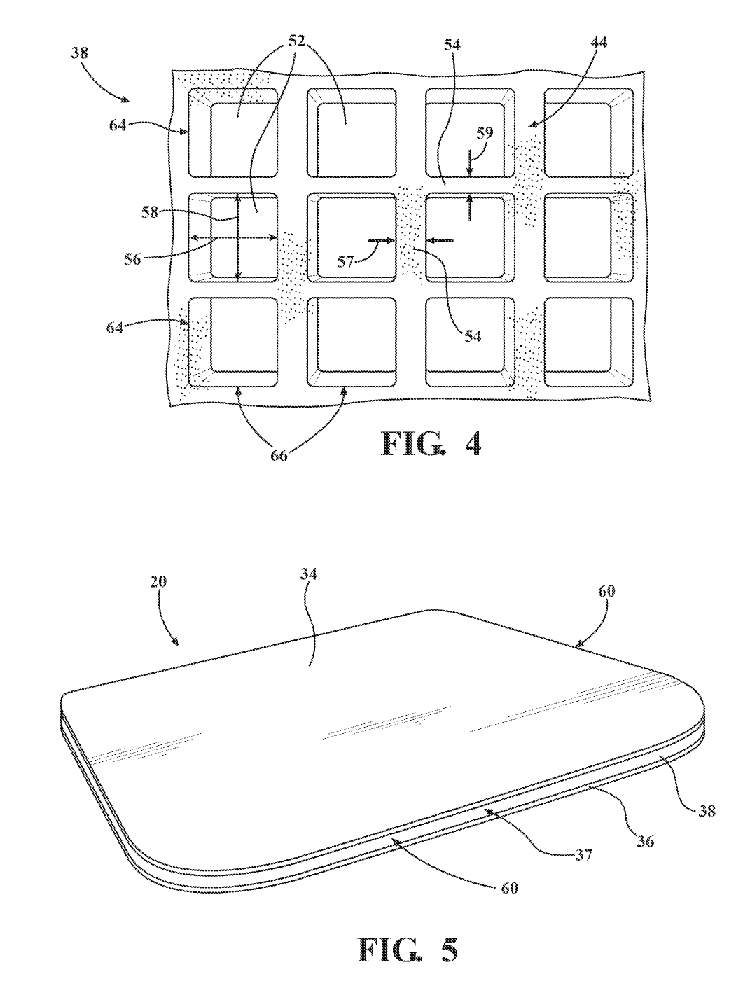

The load floor 20 provides mass savings, by virtue of the hollowed structure and materials used for the substrate layer 38. Further, with reference to FIG. 5, the load floor 20 is configured to absorb energy when a force 60 is applied to the periphery of the load floor 20. More specifically, the cells 52 of the substrate layer 38 are configured to collapse and/or deform in response to the force 60 being applied to the periphery of the load floor 20 that is in generally perpendicular relationship to the walls 54 of the substrate layer 38. When the force 60 is applied to the peripheral edge 37, the walls 54 deform, causing the corresponding cells 52 to collapse and deform. As such, by virtue of the first facing layer 34, the second facing layer 36 being bonded to the substrate layer 38, the entire load floor 20 assembly is configured to deform upon the application of the force 60 to the periphery of the load floor 20.

Additionally, referring again to FIGS. 1 and 2, a carpeting layer 62 may be secured or otherwise bonded to the first facing layer 34 and about the peripheral edge 37 of the load floor 20. As such, the first facing layer 34 is disposed between the carpeting layer 62 and the substrate layer 38.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A load floor for a vehicle comprising:
a first facing layer presenting a first inner surface; and
a substrate layer presenting a first outer surface and a second outer surface in opposition to the first outer surface;
wherein the substrate layer defines a plurality of cells bounded by at least one wall extending between the first outer surface and the second outer surface.

2. A load floor, as set forth in claim 1, wherein the cells are aligned in a plurality of rows and a plurality of columns to form a grid-like pattern.

3. A load floor, as set forth in claim 2, wherein each cell is bounded by four walls such that the cells have a square-shaped profile.

4. A load floor, as set forth in claim 3, wherein the walls of the cells have a first thickness that spaces the cells from one another along each of the rows and a second thickness that spaces the cells from one another along each of the columns.

5. A load floor, as set forth in claim 4, wherein the first thicknesses and the second thicknesses are equal to one another.

6. A load floor, as set forth in claim 4, wherein the walls extending in a direction of the rows have a first length and the walls extending in a direction of the columns has a second length;
wherein the first thicknesses are approximately ⅓ of the first lengths of the walls; and
wherein the second thicknesses are approximately ⅓ of the second lengths of the walls.

7. A load floor, as set forth in claim 1, wherein the substrate layer is formed from a material that includes high density foam.

8. A load floor, as set forth in claim 1, further comprising:
a first adhesive layer disposed between the first inner surface and the first outer surface such that the first adhesive layer bonds the first facing layer to the substrate layer.

9. A load floor, as set forth in claim 8 further comprising:
a second facing layer presenting a second inner surface; and
a second adhesive layer disposed between the second outer surface and the second inner surface such that the second adhesive layer bonds the second facing layer to the substrate layer.

10. A load floor, as set forth in claim 1, wherein at least one of the first facing layer and the second facing layer includes at least one of polypropylene, thermoplastic, glass fiber, and wood.

11. A vehicle comprising:
a floor panel;
a tub portion disposed adjacent the floor panel and presenting a cargo space defining an opening in the floor panel;
a load floor configured for selectively covering the opening and supporting various loads positioned thereon, the load floor including:
a first facing layer presenting a first inner surface; and
a substrate layer presenting a first outer surface and a second outer surface in opposition to the first outer surface;
wherein the substrate layer defines a plurality of cells bounded by at least one wall extending between the first outer surface and the second outer surface.

12. A vehicle, as set forth in claim 11, wherein the cells are aligned in a plurality of rows and a plurality of columns to form a grid-like pattern.

13. A vehicle, as set forth in claim 11, wherein each cell is bounded by four walls such that the cells have a square-shaped profile.

14. A vehicle, as set forth in claim 11, wherein the walls of the cells have a first thickness that spaces the cells from one another along each of the rows and a second thickness that spaces the cells from one another along each of the columns.

15. A vehicle, as set forth in claim 14, wherein the first thicknesses and the second thicknesses are equal to one another.

16. A vehicle, as set forth in claim 11, wherein the walls extending in a direction of the rows have a first length and the walls extending in a direction of the columns has a second length;
wherein the first thicknesses are approximately ⅓ of the first lengths of the walls; and
wherein the second thicknesses are approximately ⅓ of the second lengths of the walls.

17. A vehicle, as set forth in claim 11, wherein the substrate layer is formed from a material that includes high density foam.

18. A vehicle, as set forth in claim 11, wherein the load floor further includes a first adhesive layer disposed between the first inner surface and the first outer surface such that the first adhesive layer bonds the first facing layer to the substrate layer.

19. A vehicle, as set forth in claim 18, wherein the load floor further includes:
a second facing layer presenting a second inner surface; and
a second adhesive layer disposed between the second outer surface and the second inner surface such that the second adhesive layer bonds the second facing layer to the substrate layer.

20. A vehicle, as set forth in claim 11, wherein at least one of the first facing layer and the second facing layer includes at least one of polypropylene, thermoplastic, glass fiber, and wood.
